(19) United States
(12) Patent Application Publication
(10) Pub. No.: US 2021/0390531 A1
(43) Pub. Date: Dec. 16, 2021

(54) DIAMOND CUSTODY SYSTEM WITH BLOCKCHAIN NON-FUNGIBLE TOKENS (NFTS)

(71) Applicant: Icecap, LLC, Dillon, CO (US)

(72) Inventors: Jacques VOORHEES, Dillon, CO (US); Alex VOORHEES, Dillon, CO (US)

(21) Appl. No.: 17/348,289

(22) Filed: Jun. 15, 2021

Related U.S. Application Data
(60) Provisional application No. 63/039,350, filed on Jun. 15, 2020.

(51) Int. Cl. G06Q 20/36; G06Q 20/40; G06Q 10/08

(52) U.S. Cl. CPC G06Q 20/367; G06Q 2220/00; G06Q 10/0832; G06Q 20/401

(57) ABSTRACT

A non-fungible blockchain token (NFT) transferable from wallet to wallet on a blockchain represents ownership of a physical diamond custodied in a secure vault. The NFT can be sold and resold to investors wishing to use the diamond as a store of value. The NFT owner, who may only be known by a blockchain wallet address, can communicate with the custodian, the issuer, auditors, and more by writing signal messages into the blockchain NFT. A diamond custody controller unit at the custodian includes a trusted program module to handle private cryptographic key functions and to output retrieval and shipping instructions when a signal message indicates the NFT owner instructs the custodian to move the diamond to a new custodian. The NFT owner can also write signal messages into the NFT to instruct other parties, such as auditors, to perform services relating to the diamond.

### CROSS-REFERENCE TO RELATED APPLICATION

This application claims priority benefit to U.S. Provisional App. No. 63/039,350, entitled “Frictionless Diamond Trading with Non-Fungible Blockchain Tokens,” filed Jun. 15, 2020 and incorporated by reference herein.

### BACKGROUND OF THE INVENTION

Investors may wish to purchase precious metals or gems as a store of value for purposes of asset diversification. If the investor cannot take physical delivery, then there are investment products available (e.g., exchange traded funds) that can offer exposure to the price of the underlying asset without the investor having to have responsibility of storing and protecting the underlying asset. Shares of such an investment product can be traded to subsequent purchasers without having to move the underlying asset. These investment vehicles are most effective when the underlying asset is fungible. In other words, a particular ounce of gold or a particular bitcoin, for example, is interchangeable with any other ounce of gold or bitcoin since all units will have the same market value. Thus, investors can gain exposure to a quantity of the underlying asset as desired without concern for unique characteristics of the asset.

If an underlying asset is non-fungible, on the other hand, then it is not easily traded since each specimen of the asset has its own market value price. Examples of non-fungible assets include diamonds, memorabilia, or works of art. Since each unit of a non-fungible asset has its own set of characteristics, there is no single spot market price for a unit of the asset (e.g., there is no market price of diamonds by weight). There has never been a frictionless way for investors to trade such non-fungible assets in the same way as for fungible assets. In the case of diamonds, an investor who wishes to buy would typically buy from a retailer and sell at a street-liquidation price, which is significantly lower than even wholesale. Selling the diamond in this way results in a significant fraction of potential profits being lost and is cumbersome and frustrating as it can likely involve multiple in-person meetings to find a suitable buyer.

Accordingly, there is a need for investors who wish to gain price exposure to a non-fungible asset, such as diamonds, but who are unable or unwilling to take physical delivery of the asset, to be able to purchase and sell price exposure to individual units of the asset in a similar manner to what is available for fungible assets and to be able to trustlessly manage the selection of a secure vaulting facility, choose the legal jurisdiction in which the diamond is stored, and obtain accurate verification records of the characteristics of the diamond and of the diamond's safe storage at the selected secure vaulting location. Ideally a diamond investor could accomplish the above in a trust-minimized way, wherein a blockchain smart contract plays a role in addition to the human-controlled and machine-controlled participants.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of minting a new blockchain diamond non-fungible token (NFT) based on market availability of a physical diamond and offering of the diamond NFT for sale in accordance with some embodiments.

FIG. 2 is a diagram of acquisition by a buyer of a blockchain diamond NFT representing ownership in a diamond in accordance with some embodiments.

FIG. 3 is a diagram of a diamond NFT verification and storage in accordance with some embodiments.

FIG. 4 is a diagram of an example set of read contract options for a blockchain smart contract managing a collection of NFTs representing ownership in physical diamonds in accordance with some embodiments.

FIG. 5 is a diagram of an example set of write contract options for a blockchain smart contract managing a collection NFTs representing ownership in unique physical diamonds in accordance with some embodiments.

FIG. 6 is a diagram of another example set of write contract options for a blockchain smart contract managing a set of NFTs representing ownership in unique physical diamonds in accordance with some embodiments.

FIG. 7 split diagram of a divestment of a diamond NFT via a diamond marketplace in a first section and a divestment of a diamond NFT by direct blockchain transfer to a subsequent buyer in a second section in accordance with some embodiments.

FIG. 8 is a timeline of example events and associated smart contract function reads or writes for the purchase and custody of a diamond NFT representing ownership in a physical diamond in accordance with some embodiments.

FIG. 9 is a continued timeline of example events and associated smart contract function reads or writes for the purchase and custody of a diamond NFT representing ownership in a physical diamond in accordance with some embodiments

FIG. 10 is a schematic diagram of secure vaulting location and diamond custody controller unit connected thereto in accordance with some embodiments.

FIG. 11 is a schematic diagram of a diamond custody controller unit in connection with a secure vaulting location in accordance with some embodiments.

FIG. 12 is an example dashboard for a diamond NFT owner in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Disclosed herein is a diamond custody system wherein a diamond owner also owns a non-fungible token (NFT) on a blockchain that represents ownership of the physical diamond stored in a secure vaulting location. Blockchains are an instrument for a group of participants to share and agree to on updates to a shared ledger, which may be a public ledger. Early blockchains resembled a common ledger or spreadsheet to track balances of a quantity associated with unique addresses. In many cases, the quantity tracked is viewed as being an amount of a coin. An address, or collection of related addresses, can be viewed as a wallet that can hold and spend the coin. Bitcoin, for instance, is a ledger of coin balances across many wallet addresses.

Later blockchains extended the concept of a spreadsheet-style ledger to a more general-purpose programmable computer. A virtual machine execution environment can be provided on the blockchain that can execute compatible programmed computer applications. An update to the ledger in this type of blockchain is not merely a credit or debit to an account, but rather is the output of the program application when run on the virtual machine. On such a platform, a token computer program can be written to create a token with desired characteristics. The owner of the token program could have certain privileges including the ability to mint and burn tokens, place restrictions on the movement of tokens, edit existing tokens, etc. Another way to circulate a new token on an existing blockchain is according to a token interface such as the ERC-20 or ERC-721 token interfaces on the Ethereum network. These token interfaces are a template design of tokens that could be reused across many different blockchain projects.

Even blockchains that do not provide a virtual machine could still support the creation and management of blockchain tokens as described herein, for example through the use of a colored coin or conditional logic based on encumbrances on unspent transaction outputs (UTXOs) or on protocols such as the Omni Protocol on the bitcoin network. For the sake of simplicity, this disclosure will focus on the type of blockchain that does provide a programmable virtual machine, as typified by the Ethereum Virtual Machine on the Ethereum network, even though the disclosure is not necessarily so limited to a similar type of blockchain to Ethereum.

Whatever the type of blockchain, the ledger is updated according to a set of consensus rules applied by the participants in a network of the blockchain. The ledger updaters could be miners in the case of a proof-of-work based chain, but other types of ledger validation also exist such as various proof-of-stake and voting protocols. The principles disclosed herein apply whether the blockchain validators are running programs that implement the token behavior and characteristics described herein or whether the spending and encumbering of UTXOs is the basis for the token behavior.

One type of token that can circulate on a blockchain is a non-fungible blockchain token (NFT, can be pronounced “nifty”). In contrast to the majority of blockchain digital assets that are fungible, an NFT has at least some characteristic that is unique to a particular token and not shared with the other tokens. The unique characteristic could be as simple as a single field of the token in which arbitrary data can be stored such as a link to a centralized website. Other NFTs are more sophisticated, with multiple data storage fields, including data that only certain blockchain wallet addresses are permissioned to change, and data storage fields that are updated by the smart contract itself

Since an NFT has a unique data payload that remains attached to the token even as the NFT moves among any number of different wallet addresses (e.g., the NFT is bought and sold as many times as the traders want to buy and sell it), the NFT can be an instrument for representing a unique thing. The unique thing could be fictional or intangible, as in blockchain games where the NFT is a unique character or where the NFT is a card in a card trading or card-based game. The unique thing represented by an NFT could also be a non-fictional physical object such as representation of a work of art or property of some kind. Physical characteristics of a real-world object can be recorded and stored in an NFT. The non-fictional NFT case does differ from the fictional NFT case in that, with a fictional NFT, the entirety of the unique thing is on the blockchain and in our imaginations, whereas with a physical object NFT, there are two pieces: the physical object and the NFT representation of the physical object circulating on the blockchain.

Disclosed herein is a system for a diamond NFT on a blockchain representing ownership of a real physical diamond in a secure vaulting location. The NFT can be minted and maintained with a list of characteristics gleaned from a physical inspection and/or verification of the diamond, such as by a certified inspection authority. Once minted, the diamond NFT can be sold and resold as much as desired among investors wishing to obtain financial exposure to the value of the physical diamond sitting in storage.

The entity who controls the blockchain wallet currently holding the diamond NFT can exercise control over the physical diamond by calling smart contract functions authorized to be called only by the blockchain wallet holding a diamond NFT. The smart contract functions callable by the blockchain wallet holding the diamond NFT can include signal messages written to a writable area of the NFT. The signal messages can indicate to other participants in the system that the diamond owner desires change to the custody of the diamond or the provision of services such as auditor services who can verify the existence of the correct diamond in the secure vaulting location or that the physical characteristics of the NFT match the characteristics coded into the NFT.

Writing signal messages to the NFT on the blockchain addresses a problem present in other third-party physical custody arrangements wherein an owner of a custodied asset must prove identity and ownership before a custodian will act on the custodied asset, such as releasing the asset to the owner or transferring the asset to another custodian. In conventional custodial relationships, proving an owner's identity is necessary because it guards against theft or misappropriation of the custodied assets. There are privacy compromises that must be made by the owner to prove identity in this way to the custodian. Providing identity documents and other sensitive information to the third-party custodian creates a risk that the custodian could leak the identity and reveal, either to attackers or publicly, that the owner has ownership of the assets. Ownership of valuable assets is sensitive information because it can make the owner a target of theft attacks. Knowing that a particular person owns diamonds or other valuable assets creates an opportunity for the attackers to fraudulently request withdrawal of the asset, which is easier if the attackers know who they would need to impersonate to fool the custodian.

Another problem with existing third-party asset custody arrangements arises when the owner of the custodied asset wishes to sell the asset. If the owner of a custodied physical asset wishes to sell, then it is likely necessary to physically retrieve the asset from the vault and directly transfer it to the buyer. This is problematic in several situations. The owner of the custodied asset may not be in the same geographical region as the custodied asset and may not be able to physically retrieve it. To retrieve the asset may require traveling long distances, which may not be practical or economical.

In cases where an asset owner wishes to sell the asset, but the asset is not retrieved, then there would have to be a documented transfer of ownership presented to the custodian before the custodian could recognize the buyer as the new owner. This also presents privacy issues relating to the new owner, who would be required to identify himself to the custodian. Transferring ownership in this way may encounter issues with respect to KYC (Know-Your-Customer) regulations, wherein the custodian may either be blocked from transferring ownership to the buyer without onerous compliance obligations or may not even be allowed to transfer ownership at all if the buyer cannot provide the identity information or is otherwise barred from doing business with the custodian.

Using a blockchain NFT with a writable area for signal messages to represent ownership of the custodied assets addresses the aforementioned problems with prior third-party custody systems. An important implication of the NFT being on a blockchain is that the NFT may be traded or transferred among owners without involvement of a third-party or with only minimal involvement of a third party wherein the third party performs certain tasks related to the sale but is not relied upon in a way that could stop the sale or endanger the asset. For example, the buyer and seller of the NFT may rely on an NFT marketplace to advertise that the NFT is for sale and to manage the bidding process, but the actual payment and transfer of the NFT still occurs trustlessly on the blockchain. In this way, if the NFT marketplace is fraudulent or incompetent, likely the worst outcome is that the sale fails and the would-be seller retains the asset. If the NFT marketplace never transfers the NFT into its own wallet, then there is no risk of loss or theft by the marketplace. In other implementations, the buyer and seller of the NFT can use a so-called decentralized exchange or “dex” wherein all or almost all aspects of the sale and transfer occur on the blockchain.

Whether the NFT buyer and seller use a centralized, custodial or non-custodial marketplace to facilitate the trade or a dex, there are certain features present due to the NFT existing on a blockchain that are different from non-blockchain types of asset trades. One is that the buyer and seller likely do not know the other's identity. The NFT trade and payment therefore can be viewed as being between two wallet addresses on the blockchain. The wallet addresses are merely encodings of a public cryptographic key for which only the owner of the wallet knows the corresponding private/spending key. Unless the participants publicly associate the wallet address with their own identity, there is no way for the counterparties to know the true identities or other sensitive information (country of residence, etc.) about each other. The NFT blockchain trade therefore provides a level of privacy that is not available with other types of asset trades.

Another advantage over conventional third-party asset custody arrangements with the blockchain NFT is that privacy is continuous even if the NFT is sold and resold. There could exist a chain of ownership of the NFT representing ownership of the physical diamond of indefinite length. Each subsequent buyer gains the rights, enforced by the smart contract, to write signal messages to the writable area of the NFT, while the NFT is in the buyer's wallet. If a current NFT owner does not wish to take physical possession of the diamond, or cannot due to the regulatory environment, the NFT can simply be resold to another buyer who wishes to continue holding the NFT. By virtue of the change of blockchain wallet address currently holding an NFT, the smart contract that creates all the diamond NFTs will enforce the rule that only the current wallet address holder is allowed to call certain functions, including writing a signal message in a writeable area of the NFT on the blockchain that can only be written to by the NFT owner. Thus, the buyer can take over control of the custody, auditing, listing for sale, etc. from the prior owner.

Importantly, the transfer of ownership and rights attached to the NFT are accomplished without the buyer and the seller knowing anything about each other aside from the respective blockchain wallet addresses. There is no need to perform the steps that would be needed in a non-blockchain transaction (e.g., credit checks, escrow, KYC, identity check, etc.) Payment can be made on the same blockchain as the NFT, such as paying in ether, such that the NFT will not move to the buyer's wallet unless the buyer has made payment. This avoids the need for escrow or identity collection for purposes of billing and collection. The blockchain transaction also avoids a scenario where compliance with KYC requirements is unavoidable.

It may be that one or more of the seller, the buyer, and the custodian are in a jurisdiction wherein transfer of the ownership of the asset is subject to KYC requirements. If this is the case in a conventional custody arrangement, it may be impossible for the owner to sell the diamond. The custodian could refuse to recognize the transfer of ownership unless it has full identifying information from one or more of the parties (e.g., legal name, home address, taxpayer ID number, etc.). The custodian may be prevented from recognizing the transfer of ownership based on the country of residence of one of the parties. The custodian could simply refuse to recognize the transfer of ownership if it is uncertain whether it is legally able to do so or not. The custodied asset could be viewed as worthless to the owner if the owner is unable to sell it and transfer ownership to a buyer.

The system of the present disclosure avoids the above mentioned problems. The consequences of tracking and managing ownership of the physical diamond through the blockchain NFT is that there is no intermediary who can stop the sale or transfer. Much like the movement of cryptocurrency on a blockchain, an NFT sale can be a peer-to-peer transaction where only the buyer and seller need agree on the terms. Transfer of the asset itself is handled according to the same cryptographic principles as any blockchain transaction, and thus is as secure as the underlying cryptographic protocols of the blockchain, which often offers a very high level of confidence in the accuracy of the blockchain and assets tracked thereon. The sale cannot be blocked because the buyer is in an unfavorable regulatory jurisdiction. Any current owner can send signals to the custodian, and if the custodian chooses to or is required to ignore those signals, then the current owner can still sell the diamond ownership to a buyer who may have a better chance of being served by the custodian.

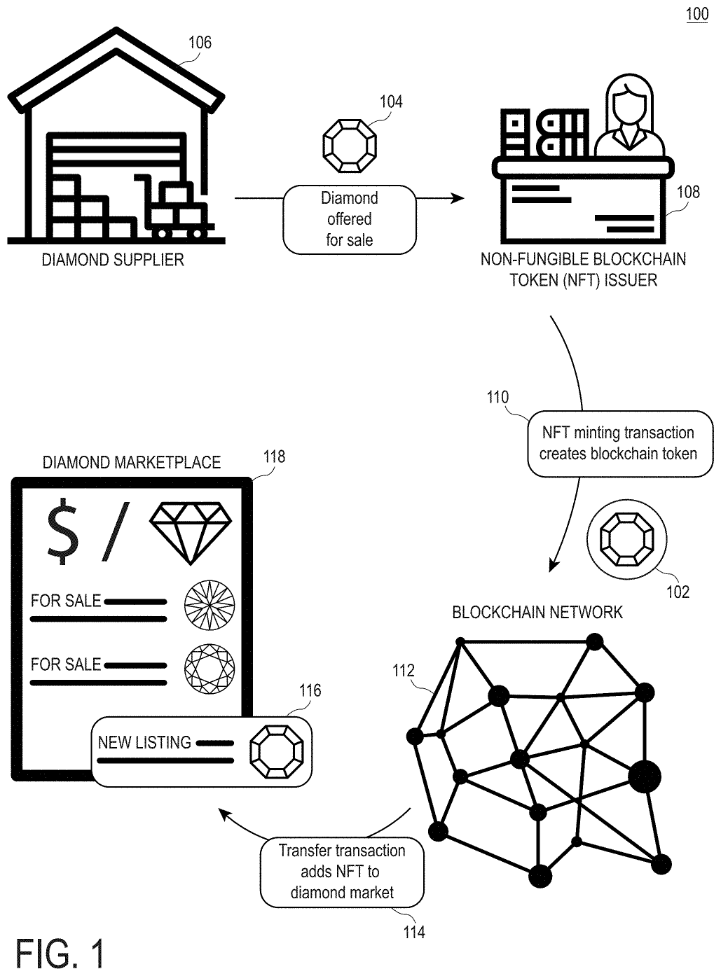

FIG. 1 is a diagram 100 of minting a new blockchain NFT 102 based on market availability of a physical diamond 104 and offering of the diamond NFT 102 for sale in accordance with some embodiments. A diamond supplier 106 offers one or more diamonds for sale at a sale price. The offer for sale includes an alleged set of characteristics of the diamond that are relevant to the diamond's market value (e.g., color, shape, clarity, cut, weight, etc.). In some implementations, the diamond supplier makes the offer for sale of the diamond 104 to an NFTs issuer 108. In other implementations, the diamond supplier 106 itself may perform the functions of the NFT issuer 108 described herein.

For purposes of this disclosure, the offer for sale of the diamond can originate with a distinct entity as shown in FIG. 1, the diamond supplier 106, or with a different entity, such as with the NFT issuer 108 itself. In other words, the NFT issuer 108 can be its own diamond supplier and use the system described herein to make sales of its own inventory. If the NFT issuer 108 is its own diamond supplier, then receiving an offer for sale of a physical diamond is a step the NFT issuer 108 performs for itself (e.g., it determines which of its own diamonds should be offered for sale and what are the corresponding metadata to each physical diamond). In other implementations, there may be many diamond suppliers 106, each sending their price lists and inventory to the NFT issuer 108 to the point where the NFT issuer 108 could even be receiving offers for sale that represent a significant fraction of the entire diamond market.

A minting operation 110 broadcasts a minting transaction to a network of a blockchain 112 to create a new diamond NFT 102. The minting operation 110 must create a transaction that is valid, and thus will be confirmed to the blockchain ledger, by the blockchain network 112. The minting transaction itself may be according to any of the methods described herein. For example, the minting transaction could create the new diamond NFT compliant with the ERC-721 interface on the ethereum network. In other implementations, the minting transaction is not necessarily an ERC-721 compliant transaction and may include features that are not available according to the ERC-721 standard (e.g., the new diamond NFT could include a feature that allows the NFT issuer to edit characteristics of the diamond as stored in the NFT after the NFT has been created.

In the example illustrated in FIG. 1, another blockchain transaction 114, which is a transfer transaction, is confirmed by the network of the blockchain 112. In an implementation, the transfer transaction creates a new listing for sale of the NFT 102 on the diamond marketplace 118. Such a transfer transaction may be needed if the NFT issuer 108 wishes to sell the NFT on an established blockchain digital asset marketplace, which likely will require deposit of the digital asset and a minimum number of confirmations on the blockchain before the NFT is permitted to be traded. In other implementations, the NFT issuer 108 can offer the NFT 102 for sale directly to buyers, for example in an over-the-counter (OTC) transaction. In such an implementation, the transfer transaction 114 may transfer the NFT directly to the buyer on the blockchain rather than transfer to the diamond marketplace 118. What is important is that the new listing 116 is displayed in a place where it is visible to a potential investor in the diamond NFT who wishes to gain price exposure to the underlying asset, in this example the physical diamond 104, by buying the NFT 102.

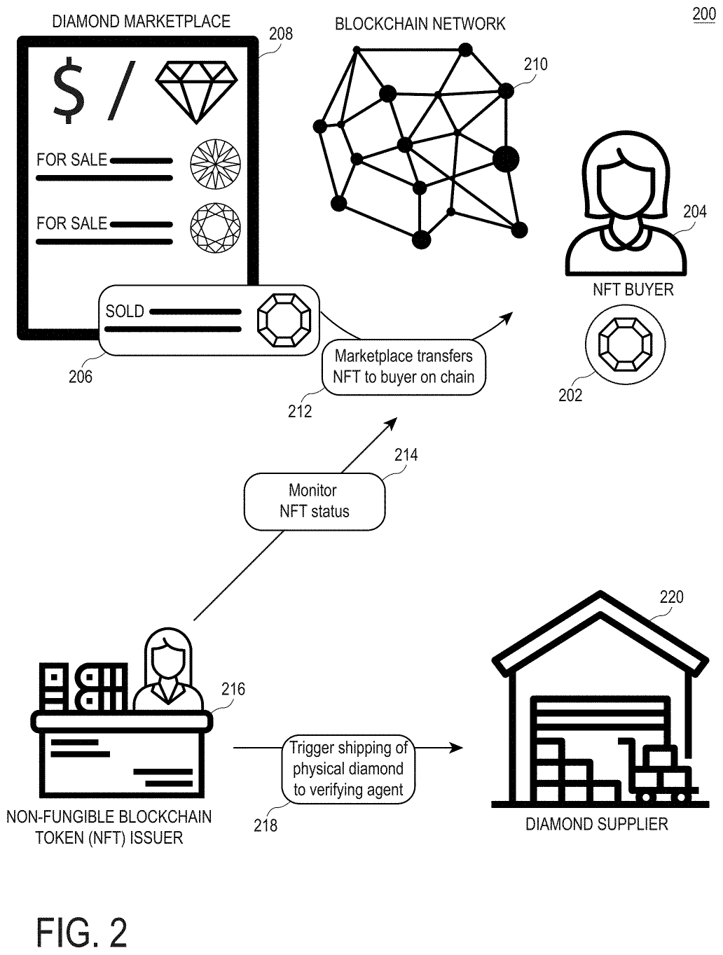

FIG. 2 is a diagram 200 of acquisition by an NFT buyer 204 of a blockchain NFT 202 representing ownership in a diamond in accordance with some embodiments. In the example illustrated in FIG. 2, the blockchain NFT 202 is sold to a buyer 204 based on a listing 206 on a diamond marketplace 208. The NFT buyer 204 receives the NFT 202 to a wallet address she controls in operation 212 after her order on the diamond marketplace 208 to purchase the NFT 202 has been filled. Operation 212 may include the diamond marketplace 208 broadcasting a withdrawal transaction to the blockchain network 210 that, when confirmed, transfers the diamond NFT 202 to the wallet of the NFT buyer 204. In other examples, the NFT 202 may be sold through instruments other than a diamond marketplace, such as a direct sale and transfer of the NFT on the blockchain network 210. No matter whether the diamond NFT is transferred directly to the NFT buyer 204 or via a marketplace, the NFT buyer 204 makes a payment to the seller. The payment can be direct or indirect via the diamond marketplace 208. For example, the NFT buyer 204 can have a funded account on the marketplace 208 and the marketplace 208 transfers funds to an account of the seller, whether in cryptocurrency, a stablecoin, fiat currency, etc. In other implementations, the NFT buyer 204 makes a direct blockchain payment to the NFT seller.

In an implementation, the NFT issuer 216 repeats a monitoring operation 214 to monitor the status of the NFT 202. The monitoring operation can be checking a copy of the blockchain updated by the blockchain network 210 to determine when the NFT has been confirmed to the wallet address of the NFT buyer 204. The monitoring operation 214 can also include direct monitoring of the diamond marketplace 208 to determine when an NFT sale has occurred. Upon determining that the NFT 202 has been sold, the NFT issuer 216 may initiate an operation 218 to trigger the diamond supplier 220 to ship the physical diamond to a verifying agent.

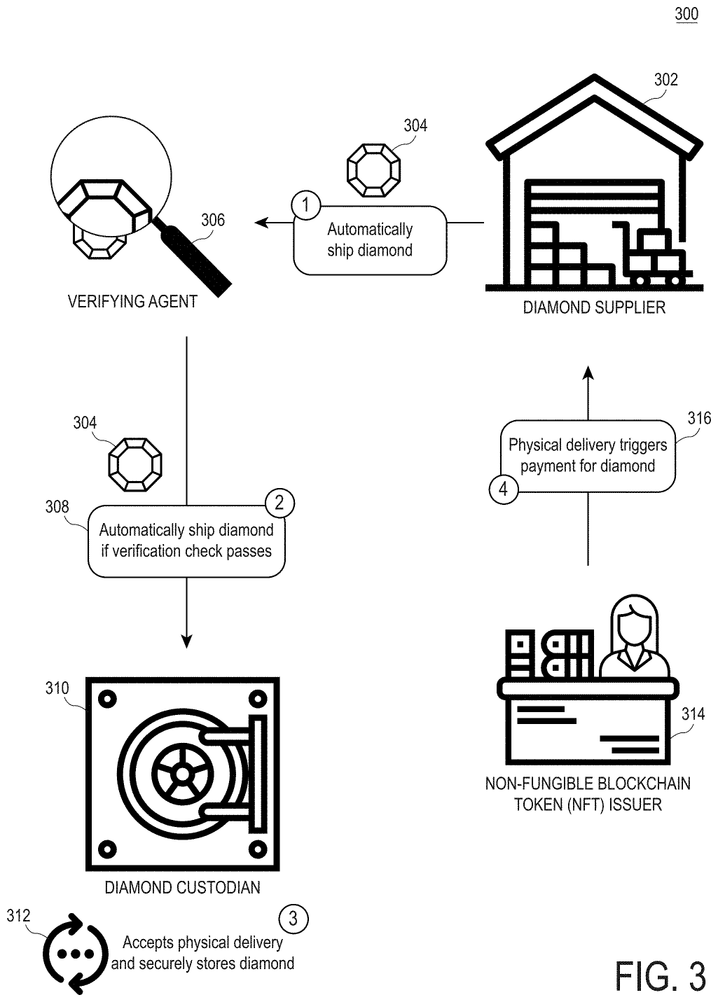

FIG. 3 is a diagram 300 of a diamond NFT verification and storage in accordance with some embodiments. When the physical diamond was initially offered for sale, the sale offer was accompanied by a list of characteristics of the physical diamond itself. These characteristics are key to determining the market value of the diamond. If it turns out the advertised characteristics are not a true representation of the physical diamond, then the NFT buyer may no longer wish to purchase the diamond NFT. To provide the NFT buyer with a level of confidence that the physical diamond 304 represented by the diamond NFT accurately matches what was advertised and what is inscribed on the NFT, the diamond supplier 302 makes physical delivery of the physical diamond 304 to a verifying agent 306. The verifying agent 306 may be an independent inspector who is skilled in diamond measurements and who can perform a verification check of the reported characteristics of the physical diamond 304. If the check passes (e.g., within a predetermined tolerance to account for potential small variations in diamond appraisal), the verifying agent 306 ships the physical diamond 306 in a delivery operation 308 to the diamond custodian 310.

The shipping operation 308 includes a deposit where the verifying agent accesses a vault or other type of secure storage and deposits the physical diamond 304 therein (e.g., a safety deposit box). In other implementations, the diamond custodian accepts physical delivery in an operation 312 and handles secure storage directly.

Upon completion of a passing verification check, the NFT issuer 314 may transmit payment in a payment operation 316 to the diamond supplier for the physical diamond 304. In implementations where the NFT issuer 314 and the diamond supplier 302 are the same entity, then payment operation 316 is not needed.

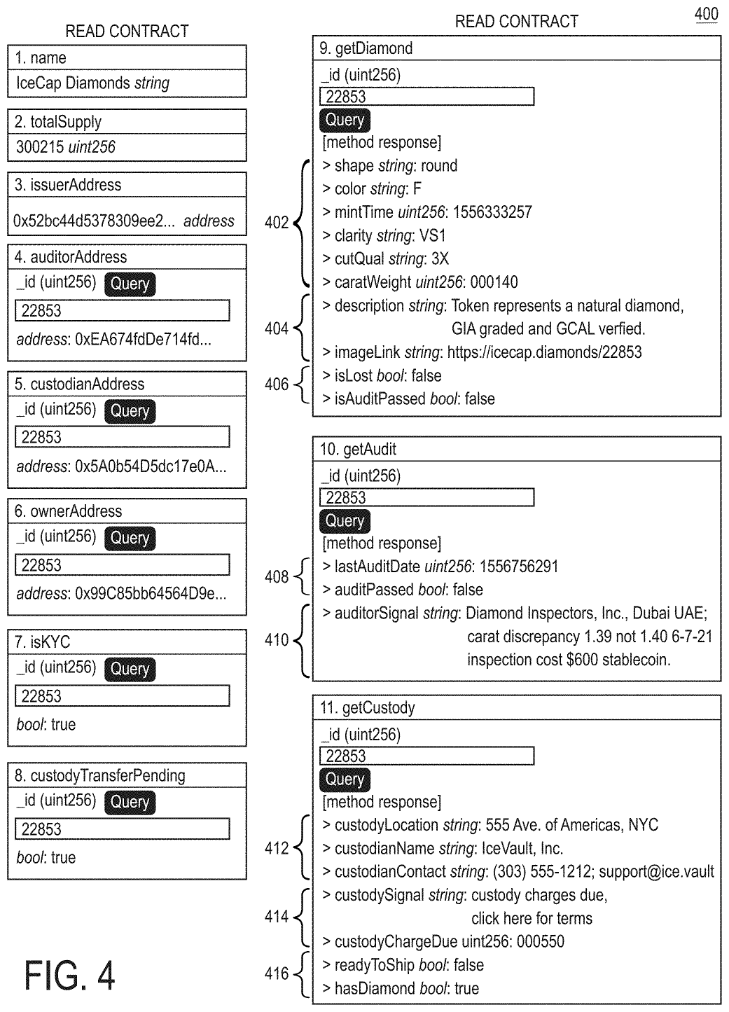

FIG. 4 is a diagram 400 of an example set of read contract options for a blockchain smart contract managing a collection of NFTs representing ownership in physical diamonds in accordance with some embodiments. In the illustrated implementation, the collection of functions is part of a single smart contract that creates and interacts with the entire collection of diamond NFTs. The smart contract is a type of computer program that runs according to the consensus rules of the blockchain, as enforced by the network nodes applying the consensus rules. This arrangement can be viewed as a virtual machine that can run compatible code. The code can implement all the functions described herein. Unlike a conventional computer program, that may run until it is terminated by a user, the blockchain code may remain dormant until a participant “pokes” the contract by paying a fee (e.g., burning gas) for the computation resources consumed by the code in responding to the poke and executing the called function. By the term function as used in this disclosure, it is meant to refer to a computer program function that accepts parameters of certain types, performs processing, and returns a return value.

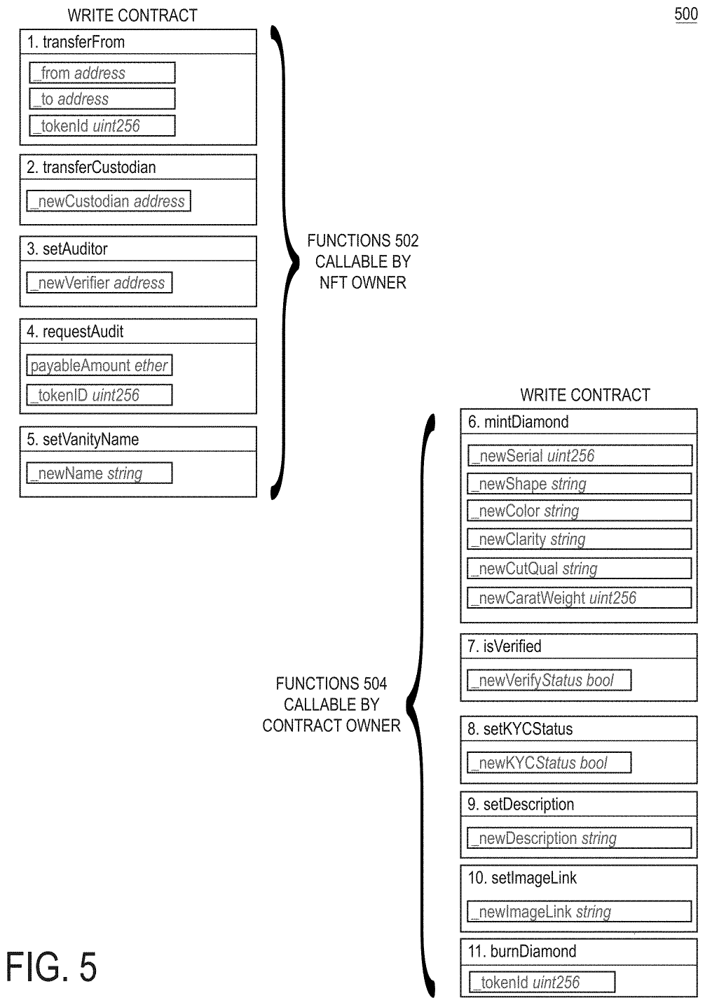

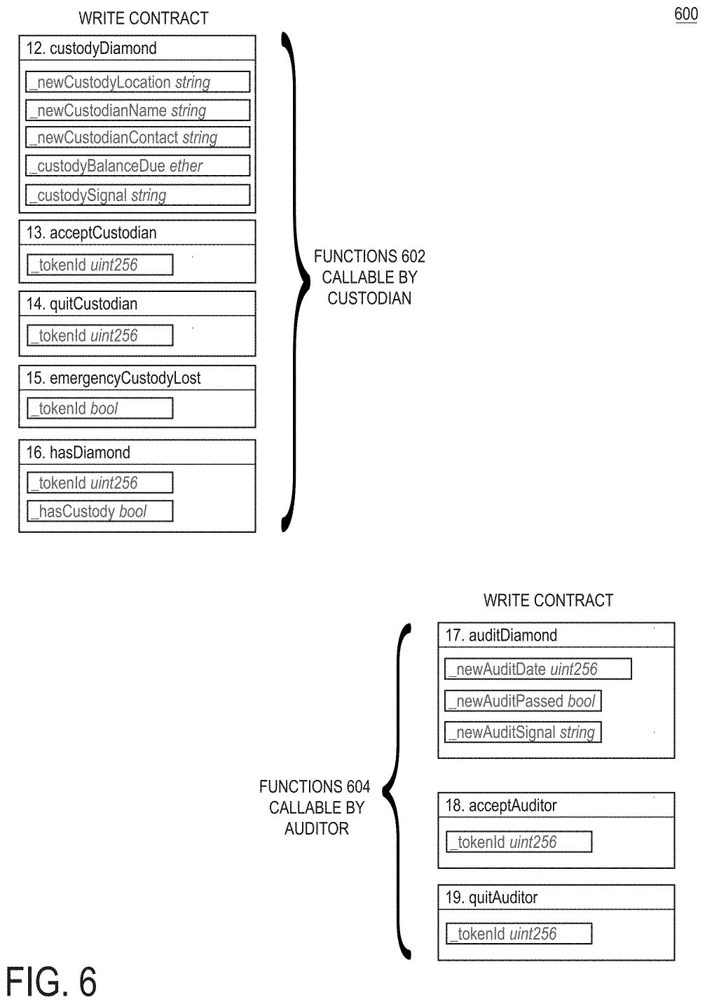

The program functions disclosed herein are divided into “read contract” functions in FIG. 4 and “write contract” functions in FIGS. 5 and 6. Read contract functions do not involve paying gas for the blockchain to execute computations. The read contract functions are merely information and, when called, return a value that has been stored by the contract. The write contract functions, on the other hand, trigger a computation and/or state change of the contract. This might involve writing data to the blockchain, which must be stored by all network nodes. To compensate for the computation and storage costs, the blockchain charges a fee for the write functions and the results of the function will not be run and written to the blockchain until a blockchain network participants “mines” a block including the transaction including the write contract call or, in a proof-of-stake chain, a validator proposes a new block containing the transaction including the write contract call.

Turning to FIG. 4, there are example read functions, numbered 1 through 11, and will be referred to herein by function number. Some of the functions retrieve information that is common to any diamond NFT in the collection. For example, function 1 returns the name of the collection, IceCap Diamonds, and function 2 returns the total number of NFTs in this collection, currently 300,215. The read contract functions may be static, like function 1 returning the name of the collection or the issuer wallet address (0x52bc44d5378309ee2 . . . ). The read contract functions also can be updateable based on state-changing operations carried out by the smart contract (e.g., 2. totalSupply increments every time a new NFT is minted).

Other read contract functions of the smart contract return information relating to a specific diamond NFT in the collection. Read contract functions that return diamond NFT-specific information include functions 4 through 11. Each of these functions take as a parameter an unsigned integer of the serial number of a diamond NFT representing ownership of a specific diamond. In the example illustrated in FIG. 4, the illustrated serial number is 22853. As depicted in FIG. 4, the functions 4 through 11 include query buttons to show how a user interface may present the output of a read function on the selected serial number 22853.

Read contract functions 4 through 6 return the blockchain wallet addresses that have certain roles, and corresponding permissions, relating to a specific diamond NFT; here, diamond NFT #22853. Function 4 returns the blockchain wallet address that has auditor permissions. The auditor wallet address may be an address that may call write functions that write data and/or signal messages to the writable area of the NFT to confirm certain aspects of the diamond, such as that the physical characteristics are correct or that the physical diamond is present in the secure vaulting location in which it is supposed to be stored. In one implementation, a custodian, upon receiving an auditing request, may require the auditor to sign a message with the private cryptographic key paired with the blockchain wallet address returned by function 4 to prove the auditor is authorized by the diamond NFT owner to perform the audit.

This disclosure may refer to the signal messages as being stored in the diamond NFT itself. One view of the NFTs disclosed herein is that they are a collection of NFTs wherein the entire collection is governed by a smart contract. The smart contract may simply include a list of address owners. Transferring the token means a blockchain wallet on the owner list calls a transfer function on the smart contract requesting the ownership be changed to a recipient's blockchain wallet address. In the same way, the writable area of the NFT can be viewed as calling a function on a smart contract that manages an entire collection of NFTs and storing the signal message in that smart contract.

Read contract function 5 returns the blockchain wallet address of the custodian of the queried diamond NFT. Like the other roles, the smart contract grants permissions to the custodian address to call other functions and to write data and signal messages to the writeable area of the diamond NFT wherein they may be read by other participants. Read contract function 6 returns the NFT owner's blockchain wallet address. In the example smart contract, whoever controls the owner blockchain wallet has permissions to call functions transferring ownership to another blockchain wallet address, such as the blockchain wallet address of a buyer of the diamond NFT.

There are various ways such a sale may be accomplished. The smart contract could include a sale or auction function itself wherein the buyer would be required to send payment to the contract itself before the owner address is updated to reflect that the buyer is the new owner. This is a safe way to handle the sale but will incur gas costs due to the smart contract computation required. Other implementations can include the seller putting the diamond NFT for sale on a centralized platform by signing a transaction that will only become valid if the buyer remits payment on-chain. Then the buyer can confirm the buy transaction after the payment has been made, thus avoiding gas costs associated with putting the NFT up for sale or auction. If a would-be seller offers the diamond NFT for sale in this scenario, but later changes her mind and wants to cancel the auction, then the seller would have to confirm a canceling transaction, thus incurring gas costs.

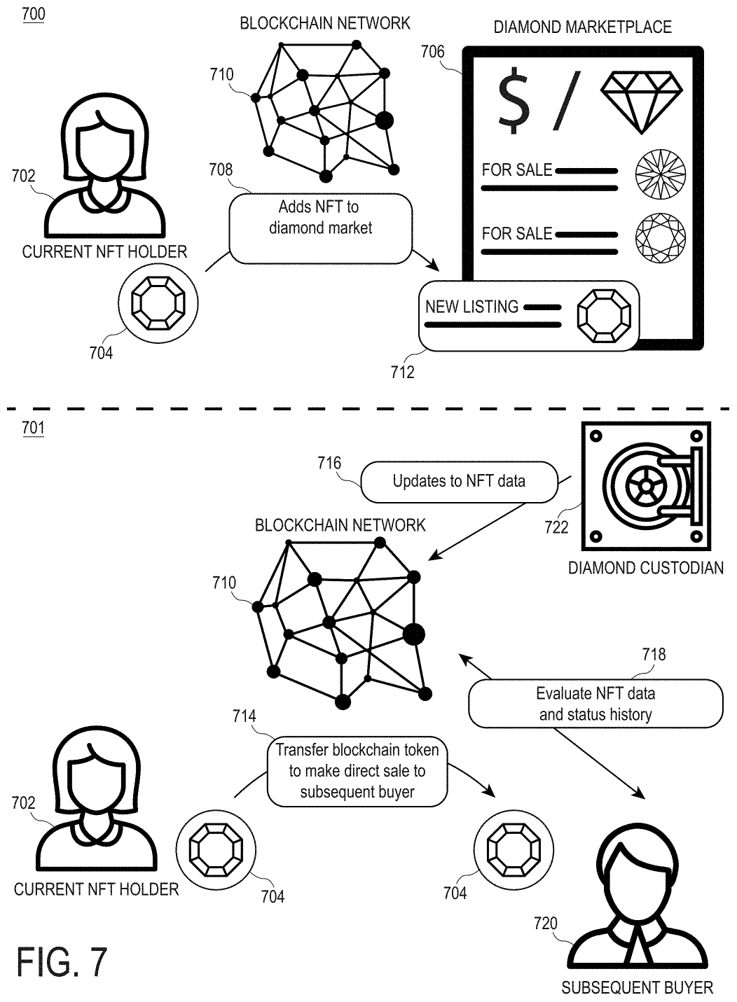

Functions 7 and 8 return the Boolean status of flags that can be set to indicate a current status of the diamond NFT. FIG. 7 shows whether the diamond NFT owner has passed KYC checks. The smart contract may include executable code to flip this KYC flag to false whenever a transfer among blockchain wallet addresses confirms to the chain. In one implementation, the issuer wallet address is the only address that has permissions to flip the KYC flag. In other implementations, the custodian can also flip the KYC flag, such as where KYC regulations vary across jurisdictions and it is up to the custodian to verify the KYC in the jurisdiction in which it is located. Function 8 is an example of a flag that can be set by the diamond NFT owner as a signal message to indicate that the owner has requested a transfer of custody to a new custodian. The function 8 flag could be reset to false after a custody transfer successfully completes or if the custodian declines or is unable to complete the custody transfer.

Function 9 getDiamond is another diamond-specific function that returns a set or array of data relating to a specific diamond NFT. The array of data returned by function 9 getDiamond includes the physical characteristics of the diamond 402, also referred to herein as the diamond profile, one or more types of signal messages 404, and one or more other status indicators 406. Any interested buyer of the diamond NFT would likely want to consult the output of function 9 getDiamond to determine the market value of the diamond to which the ownership rights attach by virtue of obtaining the NFT, especially with reference to the data 402.

Including the values 402 in the smart contract itself may be seen by buyers as strengthening the diamond NFT owner's claim of ownership over the diamond. Many popular blockchain NFTs are meant to represent ownership of something, whether abstract (e.g., ownership over a piece of art, stock share of a decentralized organization, internet meme, etc.) or more tangible (e.g., ownership over a parcel of real estate, claim to gold coins, custody of cargo or commodities, etc.). These popular NFTs, however, may not include much information about the thing supposedly owned. Often, there is only a single hyperlink stored in the NFT, perhaps to a website of the NFT issuer. If that website ever goes offline, the NFT owner would be left with merely a broken link, and no evidence to assert that the NFT proves ownership of what the holder says it does.

The present disclosure, on the other hand, is rich with information relating to the diamond, its custody, and its availability. By storing the diamond characteristics or diamond fingerprint, in the NFT itself, anyone with a copy of the blockchain will see what the owned diamond is supposed to have. Anyone wishing to replace the owner diamond with a less valuable substitute would create a conflict with what is stored in the NFT, thus exposing the substitution the next time the diamond is audited. Simply taking a website offline would not be a sufficient attack on the ownership interest as reflected by the NFT as well as it would without the fields 402 stored in the NFT itself.

In implementations, the fields 402 is immutable, meaning no participant has permissions to change it after the NFT has been issued. If the diamond NFT works as planned, then the fields 402 would never change because the diamond over which ownership is asserted did not change. That no one has permissions to change the data 402 after mint time can give a potential buyer a much higher degree of confidence that the purchased diamond NFT will at least continue to claim a diamond with the same physical characteristics as it did when the buyer purchased it and cannot be edited as would be the case if these values were actually controlled by the owner of a linked-to website which could be changed. If the fields 402 hold data that has a bearing on the market value of the diamond, then the fact that these fields 402 are “set in stone” in the sense that maybe not even the issuer has permissions to change after issuance can be referred to as the diamond profile being immutable post-issuance.

Function 9 getDiamond includes a signal message area 404. Here, participants permissioned by the smart contract, such as the issuer (as returned by function 3 issuerAddress) can call a write contract function to store contents in these fields. The stored contents could be a description of the diamond, contact info for the issuer, including a web link, or any other information the issuer sees fit to store in the token. The issuer may choose to include a small signal message in 404 and publish additional, more detailed information, on its website. There are tradeoffs between providing this information on-chain versus off-chain. On-chain incurs gas costs to confirm the data to the chain, which could be high in periods of high demand, but has the advantages of only relying on the blockchain and not relying on any third party. Off-chain information is not immutable, but is it cheap to provide a wealth of information about the NFT via a website. Using web3 protocols that involve a blockchain wallet address in a web browser, an issuer website could simply check the wallet address of the website visitor and display all diamond NFTs and all information available regarding these NFTs available from the blockchain functions described herein.

Flags 406 are optional and merely show a potential alternative to including flags callable from dedicated functions as illustrated in function 7 isKYC and function 8 custodyTransferPending. As illustrated in FIG. 4, flags 406 include an emergency flag indicating the diamond in custody has been lost. An owner of a diamond NFT with the isLost flag flipped to true would likely want to contact the current custodian as soon as possible to inquire about the custodied diamond and compensation for the loss.

The other flag 406 is called isAuditPassed and reflects whether the latest audit by the auditor found discrepancies between the fields 402 and the physical diamond in custody. Any diamond NFT owner monitoring the output of function 9 getDiamond, either directly on the blockchain (e.g., if the owner runs a full blockchain node, then the owner would be maintaining a constantly updated consensus record of his diamond NFT) or via reliance on a third party, would see that something is wrong is either of the two flags 406 become flipped to true. An NFT owner observing these flags 406 would likely want to collect more information about the diamond NFT with reference to the other functions described herein.

The next read contract function is function 10 getAudit, which takes the serial number of a diamond NFT and returns values relating to the auditing of the physical diamond. In the example illustrated in FIG. 4, fields 408 includes the last audit date in integer format (e.g., reference to the block height on the blockchain on which the NFT smart contract runs) and the auditPassed flag is a Boolean. Fields 410 is a signal message from the auditor to the owner of the NFT. Here, the string states the contact information of the auditors, the reason for setting the isAuditPassed flag to false, and the cost charged for diamond audits. An NFT owner who discovers the isAuditPassed flag has been set to fail, can consult the signal message output by function 10 getAudit to obtain this additional status of the audit.

Function 11 getCustody returns information relating to the custody of the diamond represented by the diamond NFT. As described above, the NFT trades freely on the blockchain, with buyers and sellers not necessarily knowing anything about the counterparty except the counterparty's blockchain wallet address. Some investors may find this arrangement favorable because the blockchain wallet address is a mathematically generated string that does not reveal any information about the owner that the owner might wish to keep secret (e.g., name, address, legal jurisdiction of residence, etc.).

Although very private, this arrangement presents problems for instructing the custodian and paying the custodian fees due on the diamond vaulting services. The present disclosure solves this problem by a writable area in the NFT including information relating to the custody and the custodian. Any owner of the NFT, or potentially anyone with a copy of the blockchain, can read the fields 412 to read the custodian's name, location, and contacts. If everything is to the satisfaction of the NFT owner, then no further action is required. On the other hand, if the NFT owner wishes to change the custody conditions from what is shown at 412, then the NFT owner can call the writable functions described herein to write a signal message in the writable area to signal to the custodian that changes to the custody arrangement are desired.

Fields 414 is a special field tracking the custody charges due on a diamond NFT. Presumably, securely vaulting a diamond carries costs. The longer a custodian is responsible for safe keeping of a diamond, likely the more custody charges will accrue. As explained above, the participants herein may not know anything more about the NFT owner than the diamond NFT owner's blockchain wallet address. That complicates the process of the custodian charging for vaulting services. There are generally not automatic charge arrangements with cryptocurrency wallets like there are with credit cards. An escrow smart contract could be arranged to pre-pay custody costs. In another implementation, the costs accrue as shown in FIG. 4 and any current NFT holder, or anyone with a funded blockchain wallet for that matter, can satisfy the accrued vaulting costs by sending a cryptocurrency or digital asset to the custodian's blockchain wallet address, which can be discovered by calling function 5 custodianAddress. The amount of charges due could be held in writable fields 414 until paid. When paid, the custodian could be relied upon to confirm a transaction zeroing out the accrued charges. In another implementation, the smart contract itself can receive the funds and zero out the writable area 414 before disbursing the funds to the custodian address. This arrangement would prevent paid NFT holders from having an NFT reflecting charges due because the custodian is delinquent in updating the writable area. Likely accrued custody charges would reduce the market value of a given diamond accordingly; thus a potential seller may wish for the blockchain to reflect payment if payment has been made and the account that would be transferred to the buyer is current.

Flags 416 are example flags that can be set, depending on the status of the diamond. The readyToShip Boolean could be set to true if the diamond is free from accrued storage cost encumbrances, the owner who requested custody transfer has been KYC'ed according to the relevant regulations, and any other requirements have been met to clear the NFT owner to submit instructions to transfer custody. The hasDiamond flag 416 can be set when a vaulting custodian is awaiting shipment from another vaulting custodian and the NFT owner wants to be aware when the new custodian safely has the diamond.

FIG. 5 is a diagram 500 of an example set of write contract options for a blockchain smart contract managing a collection of non-fungible tokens (NFTs) representing ownership in unique physical diamonds in accordance with some embodiments. Unlike the read contract functions described with reference to FIG. 4, which only involved reading from the blockchain, the write contract functions involve changing the blockchain by confirming a transaction to the chain that is mined and all nodes agree the transaction complies with the consensus rules. Running the computations included in the write function call are performed by all network nodes and incurs a transaction fee paid to miners or validators of the chain. Write contract functions are the mechanism by which the various participants can write a signal message to the writable area of the blockchain. A signal message included in the chain will be readable by anyone with a copy (e.g., all full network nodes). In this way, the recipient of the signal message, without revealing anything, can read the signal and choose to continue to hold the NFT, sell the NFT, or respond to the signal message.

The write contract functions illustrated in FIG. 5 are organized according to which participant has permissions to call the function. Write contract functions 502 are callable only by the blockchain wallet address recorded as the NFT owner's. Function 1 transferFrom is the basis transfer function to move the NFT to a different wallet address. Passing the _from address is here because the smart contract is a single contract that manages the entire collection. An NFT owner address calling this function may own more than one NFT in this collection. Which diamond NFT the owner wishes to move is therefore also passed as a parameter tokenId.

Write contract functions 2 transferCustodian and 3 setAuditor are callable by the NFT owner to change the wallet addresses of the custodian and auditor, respectively. There may be checks in the smart contract that prevent the NFT owner from unilaterally changing these values to any wallet address. For example, changing the custodian address may be restricted to an allowlist of pre-approved custodian addresses, a new custodian may not be appointed until accrued vaulting costs are paid, the diamond has not been flagged as lost or as failing an audit, etc.

Write contract function 4 is callable by the NFT owner to request that the auditor make an audit. In the implementation illustrated in FIG. 5, write function 4 includes paying a digital asset (e.g., ether) to the auditor to trigger the audit. Write contract function 4 could be programmed to fail if the auditor fee is not paid with the request. Write contract function 5 is for the NFT owner to set a vanity name that would be written into the blockchain and could be displayed wherever information about the diamond NFT is displayed.

An NFT “explorer” may be a website with an NFT dashboard and/or market for trading NFTs. As referenced above, if the NFT explorer is a so-called web3 website, then the user would not log in with a username, password, 2-factor authentication check, etc. Instead, the website would read the blockchain wallet address in the visitor's browser, automatically check the diamond NFT collection (and any other NFT collections) for the visitor's wallet address recorded as an owner. Any owned NFTs could be displayed in a dashboard together with interfaces for trading the NFT, accessing any of the read contract functions, or submitting blockchain transactions calling contract write functions. The web3 interface makes forming the desired blockchain transaction, handling signing the transaction with the private keys in the visitor's browser wallet, and verifying the transaction confirmed to the chain very easy from the user point of view. In this way, an NFT dashboard could display an owner-chosen vanity name, perhaps prominently, such as “King of the Mountain.”

Write contract functions 504 are callable by the contract owner. The contract owner, also referred to herein as the issuer, may be the blockchain wallet address returned by the read contract function 3 issuerAddress. In implementations, the issuer is the “minter” of the NFTs in this collection. Accordingly, write contract function 6, mintDiamond, includes the physical diamond characteristics of the diamond whose ownership is represented by the new NFT, including serial number, shape, color, clarity, cut quality, and carat weight. As explained above, these characteristics may be immutable, meaning the smart contract will not allow the issuer, or any other blockchain wallet address, to change the characteristics. This arrangement protects against the “broken link” problem wherein all the metadata on an NFT is centralized (e.g, stored on a single website), which, if it goes offline, leaves the NFT owner with nothing to show what she is supposed to own, other than a broken hyperlink. The present arrangement, in contrast, writes the important diamond characteristics, on which the value of the diamond chiefly depends, into the token itself If the smart contract enforces immutability of these values, a potential buyer would be able to know that by reading the smart contract code, assuming the code is published and verified against the on-chain byte code.

Write contract function 7, isVerified, is a flag that can be set once the characteristics set by function 6 mintDiamond have been verified, such as by a diamond inspector, such as the Gemological Institute of America or similar authority. In the implementation illustrated in FIG. 5, the issuer is also the one responsible for setting the KYC flag through function 8, setKYCStatus. Write contract functions 9, setDescription, and 10, setImageLink, are signal message writable areas for the issuer to maintain contact with the NFT owner, no matter who else is in the role of auditor and custodian. Finally, write contract function 11, burnDiamond, can be used by the issuer to retire a diamond that has left the system. There may be security checks on this function, since it could be used to vaporize someone's ownership claim over a valuable diamond. For example, the NFT owner could be given a period to contest the burn by calling a different write contract function, the custodian must set a flag to allow token burn, etc.

FIG. 6 is a diagram 600 of another example set of write contract options for a blockchain smart contract managing a set of non-fungible tokens (NFTs) representing ownership in unique physical diamonds in accordance with some embodiments. The functions 602 callable by the custodian include function 12 custodyDiamond, which sets the identity of the custodian as well as balance due and a signal message that can be written to the writable area of the NFT for signaling the NFT owner.

Write contract function 13, acceptCustodian, takes a NFT serial number as a parameter and, in some implementations, can be used to agree for the custodian's blockchain wallet address to be made the new custodian, such that it will be returned by read contract calls to function 5 custodianAddress and will have permissions to call the functions 602. Similarly, write contract 14 removes the custodian's blockchain wallet address from the custodian role. Write contract 15 emergencyCustodyLost can set the isLost flag in case of loss of physical diamond. Write contract function 16, hasDiamond, is a flag that can be used as a signal message to the NFT owner that the custodian has received the diamond, such as when shipped from another custodian.

Write contract functions 604 are callable by the auditor. A write contract function 17, auditDiamond, can be called by the blockchain wallet of the auditor to set audit date and results. A string can be used as a signal message to store the reason why an audit failed or a message relating to the audit to the chain. As with the other roles, write contract functions 18, acceptAuditor, and 19, quit Auditor, can be used to associate or disassociate the blockchain wallet address of the auditor with the diamond NFT number passed as a parameter.

FIG. 7 is a split diagram of a divestment of a diamond NFT via a diamond marketplace in a first section 700 and a divestment of a diamond NFT by direct blockchain transfer to a subsequent buyer in a second section 701 in accordance with some embodiments. In section 700, a current holder 702 of the NFT 404 wishes to sell the NFT 704 at a diamond marketplace 706. The current holder 702 makes a relisting transaction 708 on a network of the blockchain 410 to create the new listing 712 for the NFT 704. The new listing 712 includes the physical diamond characteristics confirmed by the verification agent and stored in the NFT 704 itself. Interested subsequent purchasers with accounts on the diamond marketplace 706 can purchase the NFT 704 and withdraw the NFT 704 from the diamond marketplace 706 with a transaction on the network of the blockchain 710 to a wallet address controlled by the subsequent purchaser.

In Section 701, the current NFT holder 702 wishes to sell the NFT to a subsequent buyer 720 outside of a centralized diamond marketplace. Since the NFT is a blockchain token, it is transferable on the network of the blockchain 710 from the current holder 702 to the subsequent buyer 720 at the time of sale. Before purchasing the NFT 704 and transferring it to his own wallet, the subsequent buyer 720 may wish to confirm the metadata in the NFT regarding the diamond's physical characteristics. The diamond custodian 722 and/or subsequent verifying agents can produce location status updates and verification reports that can be added to the NFT 704 over time. If the NFT 704 has recent status updates (e.g., confirmation of the physical location and identity of the current diamond custodian 722), then the subsequent buyer 720 can have an increased confidence that the NFT 704 accurately represents the physical diamond and can be redeemed if desired. Discussion of how the diamond custodian and subsequent verification agents can attach updates to the NFT 704 is made throughout the disclosure.

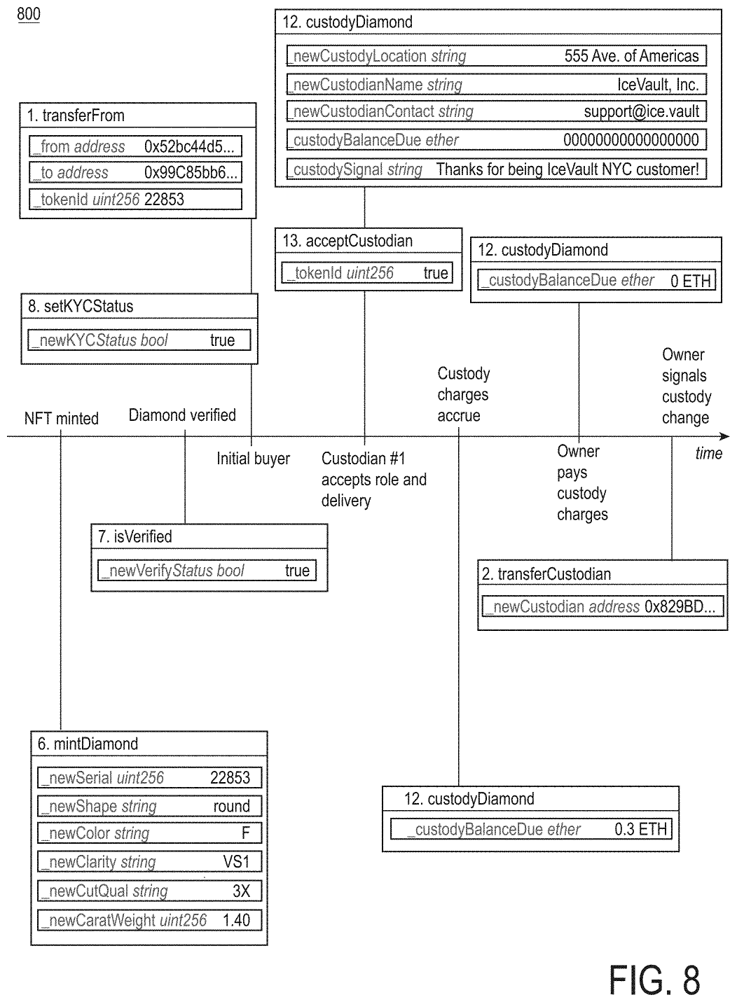

FIG. 8 is a timeline 800 of example events and associated smart contract function reads or writes for the purchase and custody of an NFT representing ownership in a physical diamond in accordance with some embodiments. Reference is made to the example functions disclosed with reference to FIGS. 4-6 but other functions could be implemented with different workflow for accomplishing the events shown on the timeline 800. The timeline 800 shows the minting of a blockchain NFT representing ownership of a diamond. An issuer calls write function 6 mintDiamond to make a new NFT instance with the characteristics of a diamond that is up for sale and a unique ID number 22853. These parameters are written into the blockchain as part of the NFT such that the NFT owner will not need to rely on a centralized platform to honestly record and provide the diamond characteristics.

The next point on the timeline 800 is verification that the diamond actually matches the characteristics recorded in the NFT. The verifier can be a verification authority who may issue a certificate attesting to the characteristics of the diamond. The issuer can call function 7 to set a flag in the NFT showing a passed verification. The next point on the timeline 800 is the initial buyer making payment for the diamond to the issuer or to the diamond supplier. The issuer sets the KYC status with a call to function 8 and transfers the NFT with a call to function 1 to the buyer.

The next point on the timeline is a custodian accepting the role of custodian with a write contract function 13 call and subsequent write contract function 12 call to set the illustrated fields. When custody charges accrue, the custodian uses its blockchain wallet to call function 12 to reflect the charges on the blockchain, which are then zeroed out upon payment.

The next element on the timeline 800 is a signal message instructing transfer of custodianship made by calling write contract function 2. The transfer custodian functionality is an important element of the present disclosure because it represents a type of “remote control” of the custody of the diamond, via the blockchain, wherein an NFT owner can use signal messages to control the physical custody conditions of the diamond whose ownership the diamond NFT represents.

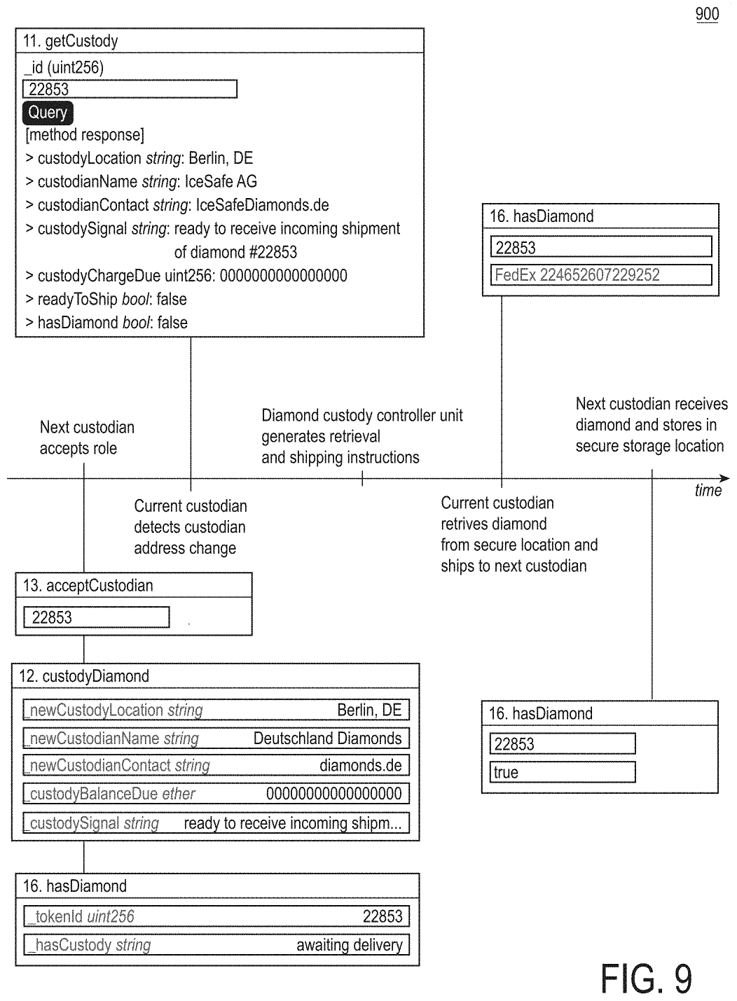

FIG. 9 is a continued timeline 900 of example events and associated smart contract function reads or writes for the purchase and custody of an NFT representing ownership in a physical diamond in accordance with some embodiments. First, the new custodian accepts the custody role by calling write contract function 13 acceptCustodian with the serial number of the diamond NFT for which the new custodian is taking the custody role. The new custodian is able to call this contract write function because the NFT owner had called the transferCustody function at the end of timeline 800. Once the new custodian has accepted custody, it can call write contract function 12, custodyDiamond with the illustrated fields including the custodySignal string to write a signal message to the diamond NFT owner on the blockchain. Finally, the new custodian flips the hasCustody flag to false.

In the next step on the timeline 900, the current custodian receives notice that the new custodian has taken over the role by seeing the output of read contract function 11, getCustody, which now shows the new custodian's information, by repeatedly and automatically checking a copy of the blockchain to detect when there is a change to any diamond NFT representing ownership of a custodied diamond via the diamond custody controller unit. Reading the custody change signal message directly from the blockchain avoids the need for privacy-infringing revealing of sensitive NFT owner information.

The next step is when the diamond custody controller unit outputs the retrieval and shipping instructions for shipping to the new custodian. This step can be premised on certain checks, including a passed KYC check and/or a zero balance due. When the diamond is shipped, the now old custodian can write a signal message using write contract function 16 hasDiamond to alert the NFT owner that the diamond is in transit. Finally, the new custodian can call the write contract function 16 again to indicate successful receiving and vaulting of the diamond.

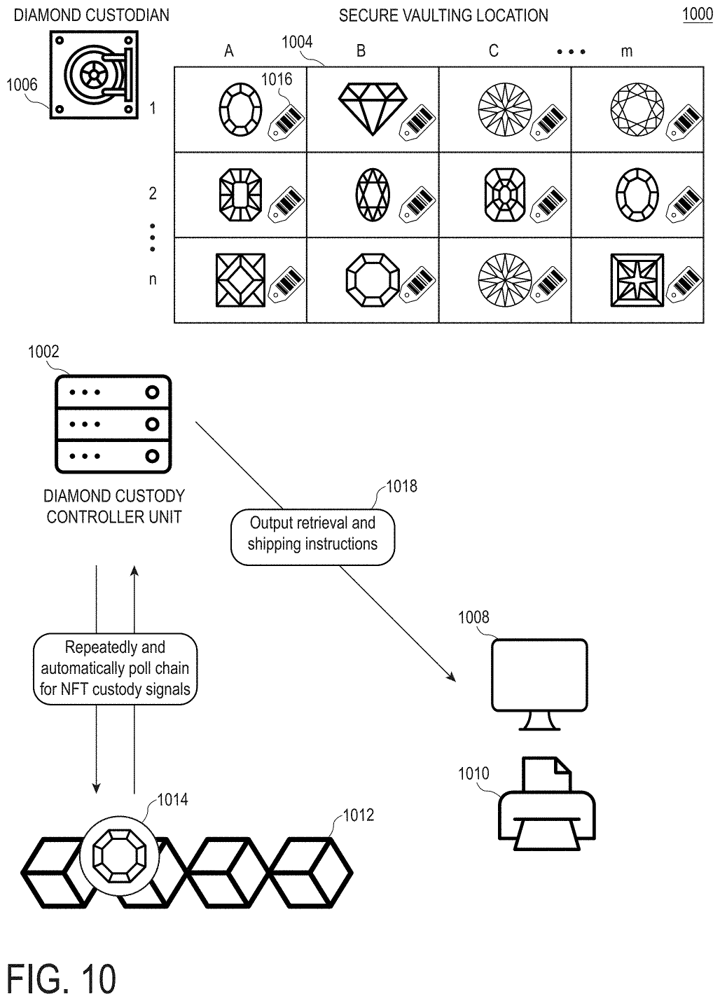

FIG. 10 is a schematic diagram 1000 of a secure vaulting location 1004 and diamond custody controller unit 1002 connected thereto in accordance with some embodiments. A diamond custodian 1006 operates the secure vaulting location 1004 storing diamonds, ownership of each diamond being represented by a diamond NFT 1014 governed by a smart contract on a blockchain 1012 having a writable area storing a diamond profile and signal messages.

There is a diamond custody controller unit 1002 is in communication with the secure vaulting location 1004 and the blockchain 1014. The purpose of the diamond custody controller unit is to automatically interface between the blockchain and the secure vaulting location to provide instructions to the operators of the secure vaulting location 1004 when a diamond NFT owner has written a signal message to the blockchain indicating instructions for the custodian. In this way, the NFT owner can “remote control” the custody of the diamond by ordering services relating to the custody of the diamond solely through the blockchain and without breaching her privacy with respect to the diamond custodian 1006. Services that the diamond NFT owner may order include change of custody to another custodian, that the custodian 1006 permit access to the secure vaulting location by an auditor to perform an audit and report thereon in the writable area of the diamond NFT. Depending on the KYC regulations applying to the diamond custodian 1006, it is possible for the custody of the diamond to be maintained, adjusted, and paid solely through the blockchain wallet address of the diamond NFT owner and without and further “real world” interaction between the NFT owner and the custodian 1006. This arrangement permits pseudonymous control of the asset no matter where in the world the diamond NFT is located.

In the example illustrated in FIG. 10, the diamond custody controller unit 1002 is a piece of specialized hardware in communication with the secure vaulting location 1004. The diamond custody controller unit 1002 may include a trusted program module (TPM), separate from generic computer components, to manage the private cryptographic keys associated with the custodians blockchain wallet address(es), signing blockchain transactions with the private keys that write signal messages to the diamond NFT or make other changes to the on-chain status of the diamond NFT, and monitor the diamond NFTs on the blockchain for a signal message that instructs the custodian 1006 to take an action.

The system disclosed herein, like many blockchain or cryptocurrency applications, depends heavily on the ability of the participants to successfully custody the private keys that are associated with their blockchain wallet addresses because it is through the blockchain wallet addresses that the various participants interact with each other through the system. If any participant lost control of the private keys to its blockchain wallet address registered with the smart contract, it would be a disaster because that participant would no longer be able to call write contract functions or to access any blockchain funds sent to that address.

It is therefore critical that the private keys not be managed on any computing system that could be insecure or attacked and controlled by attackers, who could choose to spend the funds and cause mayhem by calling inappropriate write contract functions (e.g., telling the owner that the diamond is lost when it is not). Accordingly, the diamond custody controller unit 1002 stores the private keys on a TPM where, even if the other components of the diamond custody controller unit 1002 become compromised (e.g., unauthorized access to the operating system), the private keys will remain safe. Furthermore, the diamond custody controller unit 1002 only signs blockchain transactions on the TPM such that the private keys never leave the secure part of the machine. In this way, it is exceedingly difficult for an attacker to take control of the private keys, even if the computer hardware is generally compromised.

The diamond custody controller unit 1002 maintains a list of diamond NFTs (e.g., by serial number, since that is the parameter passed to read contract functions) representing ownership of diamonds custodied in the secure vaulting location 1004. A signal message could appear on any of this list of NFTs at any time. Popular blockchains, such as the Ethereum blockchain, may produce new blocks, on average, at intervals of thirty seconds or less. Each new block in the chain could contain a confirmed blockchain transaction from an owner of a diamond NFT writing a signal message to the writable area of the NFT. To receive the signal message, the diamond custody controller unit 1002 repeatedly and automatically polls the blockchain 1012, checking the writeable area of each NFT on the list for a signal message, preferably at least as fast as new blocks are produced to stay up-to-date on the latest state of the blockchain ledger and diamond NFTs.

One way to automatically and repeatedly poll the blockchain 1012, searching for the diamond NFTs of interest, is to run a full node on the blockchain. A blockchain is a peer-to-peer network wherein nodes on the network will connect to a limited number of other nodes. This architecture is completely different from client/server architecture, which is how most of the internet works. Each of the full node peers asks its peers to send any previously unseen signed transactions. An honest peer will verify the math checks out for every signed blockchain transaction it sees, and only resent valid transactions to its peers. The peers also share any newly mined blocks encountered by the peer. The result of sharing of this information is that any peer on the network can maintain its own independent copy of the blockchain, the cryptographic correctness of which it has itself checked. If the diamond custody controller unit 1002 was a full node, then it would always have a local copy of all the diamond NFTs, updated in real-time via the peer connections. The diamond custody controller unit 1002 could automatically and repeatedly poll the local copy of the chain to determine whether custody action is instructed on any of the custodied diamonds held in the secure vaulting location 1004.

The diamond custody controller unit 1002 also maintains an up-to-date copy of the contents of the secure vaulting location 1004. An organization or addressing scheme can be used to provide coordinates to locate specific diamonds (e.g., rows labeled A-Z, columns numbered). Symbolic barcodes 1016 can be attached to each diamond in the secure vaulting location 1004 so that the diamond can be recognized by a scanner.

When the time comes that an NFT owner writes a signal message regarding custody to the writable area of the diamond NFT, the diamond custody controller unit 1002 will read the signal from a copy of the blockchain and perform operation 1018 in which retrieval and shipping instructions are presented (e.g., printed via printer 1010, shown on screen 1008, encoded into a symbolic barcode, etc.). Operation 1018 can reference the indexing scheme of the secure vaulting location 1004 and include the location on the output retrieval and shipping instructions. The output shipping instructions may include a destination custodian and shipping method.

The diamond custody controller unit 1002 may include checks before outputting the retrieval and shipping instructions that could delay the outputting of the instructions until certain conditions are met. Conditions for outputting 1018 of the retrieval and shipping instructions, for example, could be based on whether there is an unpaid accrued storage cost due on the diamond. If so, the diamond custody controller unit 1002 can automatically and repeatedly poll its copy of the blockchain to know when the accrued charges are paid (e.g., monitoring the custodian's blockchain wallet registered with the smart contract as the custodian).

Another potential limitation on the outputting operation 1018 is whether the current NFT owner requesting custody change satisfies KYC requirements. Depending on the legal jurisdiction, the custodian 1006 may not be allowed to ship a diamond if the custodian 1006 does not know the identity of the owner and potentially other sensitive identifying information on the owner. If this is the case (e.g., if the isKYC flag is set to false by the minter), then the diamond custody controller unit 1002 can be programmed not to print the retrieval and shipping instructions until the KYC is resolved. In the case that the current NFT owner cannot or does not wish to satisfy the KYC requirements with respect to the minter, the custodian 1006, or any other participant in the system, then all is not lost. Despite the regional KYC requirements, no one can stop the diamond NFT from being traded. Even if custodial exchanges refused to accept or list the diamond NFT for KYC reasons, the current NFT holder could list the diamond for sale on a decentralized exchange or dex. In this way, the non-KYC compliant owner of the diamond NFT could still sell to a buyer who was willing and able to complete the KYC checks with the custodian. The value of the diamond NFT might be diminished for a non-KYC compliant holder but it would likely still be far above zero, which is what it likely would be worth if the non-KYC owner could not access the diamond at all.

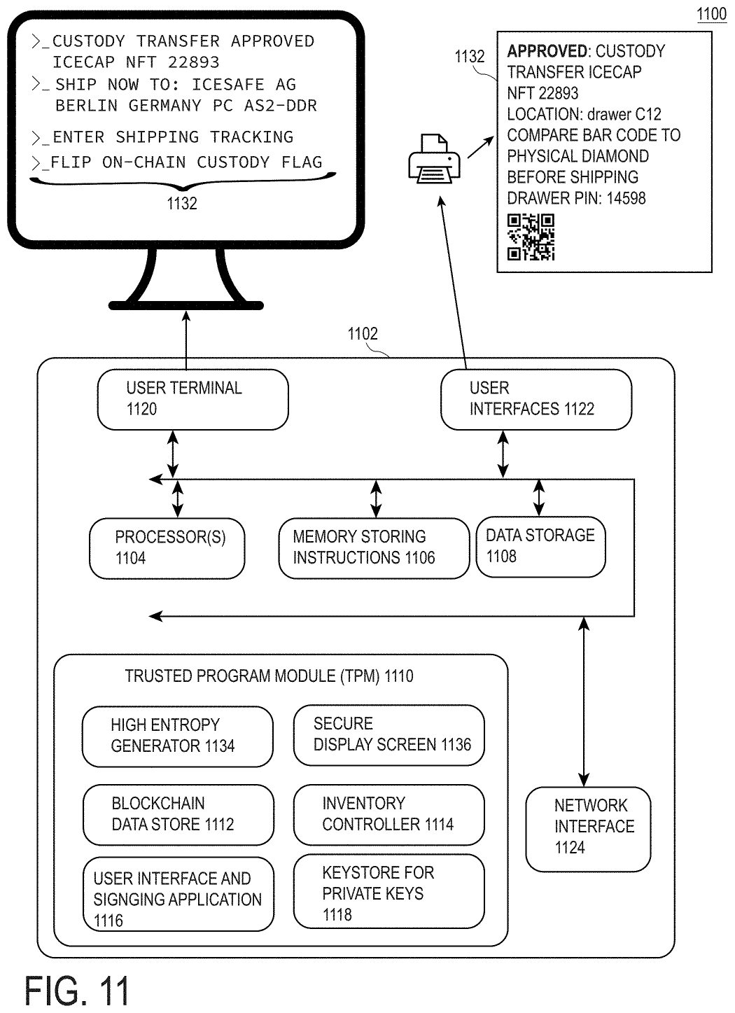

FIG. 11 is a schematic diagram 1100 of a diamond custody controller unit 1102 in connection with a secure vaulting location 1126 in accordance with some embodiments. As explained above, the blockchain diamond NFT custody system depends heavily on the participants being able to operate their blockchain wallets. Certain roles in the system are performed by calling write contract functions that only certain designated blockchain wallets addresses are allowed to call (e.g., only the owner wallet can call transfer function, only custodian wallet can flip custody flags, etc.). There is no way to recalculate the private key once it is lost due to the massive levels of entropy involved. These are the same principles that protect the wallet from brute-force attacks. But if it is computationally impractical for an attacker to brute-force a blockchain wallet, then it would be so for the rightful owner of a lost key to make the same attack. One of the roles of the diamond custody controller unit 1102 is therefore to prevent loss of the private keys.

In addition to permissions issues, the blockchain wallets store blockchain funds. Stealing the private wallet key would enable the thief to empty the wallet and spend the funds to another wallet under the control of the attacker. Blockchain transactions are irreversible and there would be no way to recover the funds. The private spending keys are therefore at risk of loss of theft, especially as the wallets accumulate larger balances. Blockchains are public ledgers and, unless the custodian or other participants take active measures to obfuscate their wallets, then an attacker could identify the custodian's address simply by calling read contract functions on the public smart contract. Connecting a valuable blockchain wallet with a physical address is a security threat, both from a physical attack or internet attack perspectives. Safe keeping of the private keys from thieves is therefore a role of the diamond custody controller unit 1102.

Another issue with the handling of the private keys in this disclosure is that the keys must have been generated with enough entropy that they are not guessable. As referenced above, the address space of all possible blockchain wallets is so vast, that even all the computing power in the world working together would take a very long time to guess a wallet private key. In other words, it would be computationally impractical to brute-force or guess a wallet key based on the massive number of possible wallet combinations. The vast wallet address space, however, only protects against attack if the wallet generator is selecting a wallet in a way that makes the whole space or at least a large fraction of the space addressable. An entropy input or source of randomness is needed to select a wallet address. It has to be random “enough” that no other person has ever selected the same wallet or ever will select the same wallet in the future. Normal sources of randomness based on generic computer hardware likely cannot generate enough entropy to safely select a wallet. Computer clocks, dates, and calendar-based randomness is not sufficient for the applications described herein. Generating high entropy is therefore also a role of the diamond custody controller unit 1102.

In view of the above outlined problems, the diamond custody controller unit 1102 includes components for automatically and continuously monitoring a list of diamond NFTs on a blockchain and responding appropriately whether through outputting instructions to a secure vaulting location, flipping on-chain flags or writing on-chain signal messages, or handling blockchain funds transfers. Due to the sensitivity of the wallet generation and wallet operations with private keys, a trusted program module (TPM) 1110 is introduced in addition to the generic computer components (e.g., processor(s) 1104, memory storing instructions 1106, data storage 1108, network interface 1124, user terminal 1120, and/or user interfaces 1122. The TPM 1110 has a dedicated set of components for carrying out the functions described herein that for security purposes could not simply be carried out on the generic computer hardware. The components on the TPM 1110 cooperate to carry out blockchain and inventory management operations.

While the TPM 1110 is a secure hardware area, it can receive input from and send output to the generic computer components in the controller unit 1102. The TPM 1110 is premised on the threat that the generic computer components have been compromised by an attacker. Whenever there are blockchain funds secured with a private key, there is an incentive for the attackers to try to steal the keys. The TPM 1110 is therefore arranged to be safe even if the rest of diamond custody controller unit 1102 has been compromised. One example of the TPM 1110 security when the rest of the controller unit 1102 is compromised is the secure display screen 1136. On a compromised computer, malicious code may run to display a wallet address to the user that is not the actual address that will receive funds. The user is fooled into thinking she is sending funds to an intended counterparty, but when the wallet signs the transaction, a hidden address is the true recipient. The secure display screen 1136 guards against this attack by displaying the recipient address on the TPM hardware. If the address shown on the TPM hardware does not match what the user sees on the generic computer components (e.g., interfaces 1122 or user terminal 1120), then the user will know an attack is underway and can move to non-compromised hardware.

Another way the TPM 1110 guards against attack is the high entropy generator 1134. The generic processor(s) 1104 likely cannot generate a high-security level of entropy, since its entropy inputs come from too small an address space (e.g., clock time, date reference, etc.). If an attacker discovered a low-entropy input was being used for creation of blockchain wallets, for example if the attacker discovered network requests to a calendar server, then the attacker could make a successful brute-force attack using the same input. The high entropy generator 1134 will use hardware to collect entropy inputs (e.g., accelerometer, vibrations, microphone input, touch screen input, camera input, etc.) that never leave the TPM 1110 and will not be leaked.

Importantly, the TPM 1110 has a keystore for private keys 1118. This element is critical for the safe signing of blockchain transactions. The private keys, generated on the TPM 1110 using the high entropy generator 1134, never leave the TPM 1110. A blockchain transaction may be generated by other components of the diamond custody controller 1102 and input to the TPM 1102, but the transaction can only be signed on the TPM 1110. Receiving only a signed blockchain transaction will not reveal the private key that signed it. The user interface and signing application 1116 works in cooperation with the secure display screen 1136 and the keystore for private keys 1118 to perform all blockchain transaction signing. The TPM hardware components may work in cooperation with the user terminal 1120 and user interfaces 1122, even though those components may not be secure.

Another component of the diamond custody controller unit 1102 is the inventory controller 1114. The inventory controller 1114 can store a position index of each diamond in the vault. The position index can be a physical description of where to find a custodied diamond within the vault. The position index may include a section number, row and/or column number, x/y coordinates, etc. From the position index, it is possible to construct retrieval instructions (e.g., retrieve diamond in drawer at section B, row 2; retrieve diamond in position C12; etc.) The user interface and signing application 1116 can use the retrieval instructions to output retrieval instructions via the user terminal 1120 and/or user interfaces 1122. In implementations, the retrieval instructions are encoded on a QR code that the custody operator can take to the secure vaulting location to double check that the correct diamond is being retrieved.

In implementations, the blockchain data store 1112 is a location that stores up to a complete history of the blockchain (e.g., a “full node”). In implementations, a “pruned” node could be maintained at blockchain store 1112, as long as the blockchain data store 1112 retains the “unspent” coins needed to process new transactions and the data relating to the diamond NFTs of interest. Storing the blockchain data store 1112 on the TPM 1110 isn't as critical as the other elements such as the private keys because it would be difficult for an attacker to change the blockchain since blockchains are particularly resistant to immutability attacks. If a non-TPM part of the diamond custody controller 1102 ran the blockchain node, the computational correctness was still independently verified locally and confidence can be high that the chain in storage is the longest chain, and therefore most likely to be correct, that the node has seen from its connected peers. Still, the blockchain data store 1112 to also be located on the TPM 1110 for additional assurances that the local copy of the ledger is the correct one.

When the user interface and signing application 1116 determines that a diamond is ready to be moved from custody, such as by the signaling of an owner of a diamond NFT by writing the instructions on the blockchain, it can cause the output of retrieval and shipping instructions to the custody operators. The retrieval instructions 1132 can be communicated via the user terminal 1120 to the custody operators or via user interfaces 1122, such as by printing. The retrieval and shipping instructions may include additional security information such as the PIN code for a lock, a passphrase or password, or other types of instructions for accessing the diamond. The custody operators can take the retrieval and shipping instructions with them when they access the vault to retrieve the diamond.

Upon completion of any of the custody tasks described herein, the keystore for private keys 1118 can sign a blockchain transaction setting the appropriate flags or writing appropriate information to the diamond NFT on the blockchain to reflect the current status of the diamond NFT. FIGS. 8 and 9 show example write contract functions that could be included in a blockchain transaction and signed by the keystore 1118 to perform the functions described herein.

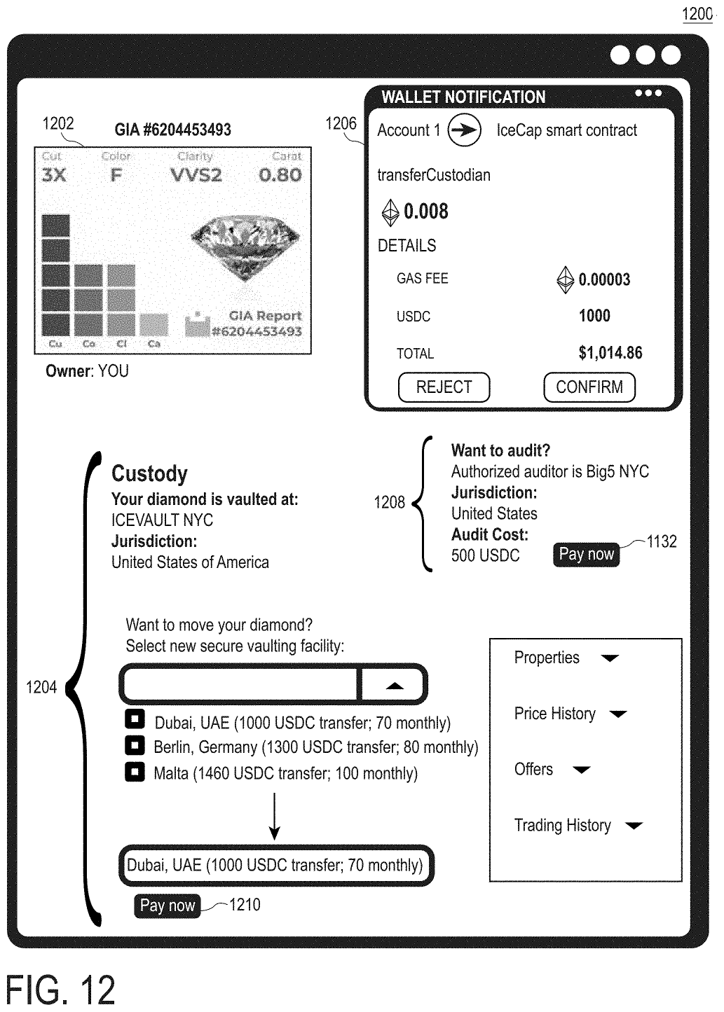

FIG. 12 is an example dashboard 1200 for a diamond NFT owner in accordance with some embodiments. User interface 1200 can assist the owner of a diamond NFT by aggregating information read from the smart contract about the diamond NFT and by presenting an interface for calling the write contract functions available to the NFT owner. The dashboard 1202 knows the NFT in section 1202 belongs to the person visiting the dashboard because of the web3 architecture. In web3 architecture, there is a wallet 1206 in the visitor's web browser (e.g., a Metamask browser). When the visitor makes an HTTP request to the web server, the request can include the blockchain wallet address of the wallet 1206. As described above, the wallet address is unique and no other user has the same one, assuming adequate entropy was available when the wallet was generated. When the web server knows the visitor's wallet address, it can search the blockchain for diamond NFTs owned by that wallet and display the visitor's NFTs on the dashboard 1200 without asking the user to log in, type a password, or make another kind of authentication. The wallet address of wallet 1206 is the authentication. Like other parts of the disclosed system, it is critical that a user of the wallet 1206 not lose the private keys to the wallet because if that happened, it would not be possible to submit a write contract call or ever transfer the NFT out of the wallet. The NFT would essentially be useless.

Once the dashboard 1200 knows which diamond NFTs are owned by the visitor, they can be displayed. The display may include a summary section 1202 showing a particular custodied diamond's physical characteristics. The display may include a custody section 1202 with custody information as well as an interface to submit write contract functions to the smart contract callable by the NFT owner. The drop-down menu in 1204 shows a constellation of secure vaulting services providers and associated costs for transferring the diamond thereto.

If the user selects a different secure vaulting location from the current location, a pay now button 1210 can appear to process the transfer. Payment is seamless because of the web3 architecture. There is still not needed a user name, password, or even an account for the user at this website. There is no third-party payment processor like a credit card or debit card company, private payment processor, or bank. The payment for custody transfer is made on the same blockchain as the diamond NFT. The pay now button 1210 populates the wallet 1206 with the details of the transaction. Included in the wallet 1206 window is the name of the smart contract to be called, the name of the write contract function, transferCustodian, the amount of digital asset to be sent (0.008 ETH in the example), gas costs to confirm the transaction, equivalent value in a stable coin (the USDC stablecoin), and the total amount to be spent on the transaction. The NFT owner can select Reject or Confirm buttons to sign the blockchain transaction and set it to be confirmed by the blockchain network via a network peer.

Another section of the dashboard 1200 is the audit section 1208. Section 1208 shows a pre-approved auditor for the current secure vaulting location. There could be one or more pre-approved auditors from which to choose, or 1208 could permit selection of a third-party auditor chosen by the NFT owner. The audit section 1208 includes a jurisdiction of the auditor and an audit cost. As with payment of the custody transfer cost, payment for an audit can be made through the web3 architecture on the dashboard 1200. If it is chosen to instruct the auditor to audit, the wallet 1206 will display a proposed transaction, with proposed transaction fees, and information regarding the write contract call for confirmation by the user that the user wants to spend from the blockchain wallet.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

Diamond custody system with blockchain non-fungible tokens (nets) claims:

1. A diamond custody system providing automatic delivery of diamonds from a diamond custodian, the system comprising:
a secure vaulting facility storing diamonds, ownership of each diamond being represented by one of a set of independently transferable diamond non-fungible tokens (NFTs) governed by a smart contract on a blockchain, the diamond NFTs having a writable area storing a diamond profile and signal messages;
a diamond custody controller unit that repeatedly and automatically polls the blockchain for each NFT representing ownership of a diamond in the secure vaulting facility to check the writable message storage area for a signal message condition; and
if the signal message condition is satisfied for one of the diamond NFTs, outputting retrieval instructions for retrieving a diamond from the secure vaulting facility ownership of which is represented by the one of the diamond NFTs and shipping instructions for shipping the physical diamond to another secure vaulting facility.

2. The diamond custody system of claim 1, wherein the diamond custody controller unit includes a trusted program module (TPM) with a TPM processor and TPM memory, protected from a general purpose computing environment, and storing a private cryptographic key paired with a custodian blockchain wallet address authorized by the smart contract to write custodian signal messages to the writable area of a diamond NFT, the TPM memory further storing executable instructions to sign a blockchain transaction with the private cryptographic key writing a new signal message to the writable area based on a changed custody status of one of the diamond NFTs.

3. The diamond custody system of claim 2, wherein the new signal message is a message that a diamond in the secure vaulting facility has accrued storage costs.

4. The diamond custody system of claim 2, wherein the new signal message is that a diamond in the secure vaulting facility has been shipped from the secure vaulting location.

5. The diamond custody system of claim 1, wherein the diamond custody controller user interface accepts an input indicating a lost physical diamond in the secure storage location, and, upon receiving said input, signs a blockchain transaction with the private cryptographic key, the transaction writing a loss signal message to the writeable area of the diamond NFT representing ownership of the lost physical diamond.

6. The diamond custody system of claim 1, wherein the retrieval instructions for retrieving the diamond, ownership of which is represented by the one of the diamond NFTs, includes a symbolic barcode matching a symbolic barcode on the diamond in the secure vaulting facility to be retrieved.

7. The diamond custody system of claim 1, wherein each of the set of diamond NFTs includes a diamond profile of diamond characteristics stored in the writable area of the diamond NFT.

8. The diamond custody system of claim 7, wherein the smart contract on the blockchain enforces that the diamond profile is immutable post-issuance.

9. A method of diamond custody with automatic delivery of diamonds from a diamond custodian, the method comprising:
storing diamonds in a secure vaulting facility, ownership of each diamond being represented by one of a set of independently transferable diamond non-fungible tokens (NFTs) governed by a smart contract on a blockchain, the diamond NFTs having a writable area storing a diamond profile and signal messages;
repeatedly and automatically, via a diamond custody controller unit, polling the blockchain for each NFT representing ownership of a diamond in the secure vaulting facility to check the writable message storage area for a signal message condition; and
automatically outputting, via a user interface connected to the diamond custody controller, retrieval instructions from the secure vaulting facility and shipping instructions for shipping the physical diamond to another physical storage location if the signal message condition is satisfied.

10. The method of claim 9, wherein the diamond custody controller unit includes a trusted program module (TPM) with a TPM processor and TPM memory, protected from a general purpose computing environment, and stores a private cryptographic key paired with a custodian blockchain wallet address authorized by the smart contract to write custodian signal messages to the writable area of one of the diamond NFTs, the TPM memory further storing executable instructions to sign a blockchain transaction with the private cryptographic key stored thereon, the blockchain transaction writing a signal message to the writable area based on a changed custody status of one of the diamond NFTs.

11. The method of claim 10, wherein the new signal message is a message that a diamond in the secure vaulting facility has accrued storage costs.

12. The method of claim 10, wherein the new signal message is that a diamond in the secure vaulting facility has been shipped from the secure vaulting location.

13. The method of claim 9, wherein the diamond custody controller user interface accepts an input indicating a lost physical diamond in the secure storage location, and, upon receiving said input, signs a blockchain transaction with the private cryptographic key, the transaction writing a loss signal message to the writeable area of the diamond NFT representing ownership of the lost physical diamond.

14. The method of claim 9, wherein the retrieval instructions for retrieving the diamond, ownership of which is represented by the one of the diamond NFTs, includes a symbolic barcode matching a symbolic barcode on the diamond in the secure vaulting facility to be retrieved.

15. The method of claim 9, wherein each of the set of diamond NFTs includes a diamond profile of diamond characteristics stored in the writable area of the diamond NFT.

16. The method of claim 15, wherein the smart contract on the blockchain enforces that the diamond profile is immutable post-issuance.

17. A system for diamond trading with diamond non-fungible tokens (NFTs) on a blockchain, the system comprising:
one or more processors; and
a computer readable medium storing instructions which, when executed by the one or more processors, cause the one or more processors to perform operations comprising:
receive an offer for sale of a physical diamond from a diamond supplier at a purchase price, the offer for sale including a diamond profile describing characteristics of the physical diamond;
broadcast a diamond NFT minting transaction to a network of a blockchain that will, when confirmed according to the consensus rules of the blockchain, create a new diamond NFT independently transferable on the blockchain representing ownership of the physical diamond, the minting transaction storing the diamond profile in the diamond NFT itself and storing in the diamond NFT itself at least one signal message;
broadcast a transfer transaction to the network of the blockchain to transfer the diamond NFT to a diamond NFT buyer;
receive a diamond NFT purchase payment from the diamond NFT buyer;
transmit a shipping request to the diamond supplier to deliver the physical diamond to a diamond verifier, the shipping request including a serial number of the diamond NFT and an address for physical delivery to a diamond custodian for storage in a vault;
receive confirmation of acceptance and storage in the vault of the physical diamond from the diamond custodian;
transmit a purchase payment to the diamond supplier for the physical diamond for the purchase price.

18. The system of claim 17, wherein the instructions cause the one or more processors to perform operations further comprising:
receive a message that the diamond NFT satisfies a redeem condition, the redeem condition being a request to redeem the physical diamond written into the diamond NFT itself and confirmed on the blockchain and including a final physical delivery address;
transmit a physical delivery request to the diamond custodian for physical delivery to the diamond verifier;
receive, from the diamond verifier, a verification of the characteristics of the physical diamond with respect to the characteristics recorded in the diamond NFT;
transmit, to the diamond verifier, a request for delivery of the physical diamond to the final physical delivery address; and
broadcast, to the network of the blockchain, a burn transaction that will, when confirmed according to the consensus rules of the blockchain, burn the diamond NFT.

19. The system of claim 1, wherein the instructions cause the one or more processors to perform operations further comprising:
receive, from the diamond custodian, a location status verification of the physical diamond; and
write the location status verification of the physical diamond into the diamond NFT itself.

20. The system of claim 1, wherein the instructions cause the one or more processors to perform operations further comprising:
broadcast, to the network of the blockchain, a storage fee signal message transaction that will, when confirmed according to the consensus rules of the blockchain, write a storage fee due signal message into the diamond NFT itself;
determine that the storage fee has been paid; and
broadcast, to the network of the blockchain, a clearing transaction that will, when confirmed according to the consensus rules of the blockchain, remove the storage fee due signal message
